(19) United States
(12) Patent Application Publication
(10) Pub. No.: US 2014/0377469 A1
(43) Pub. Date: Dec. 25, 2014

(54) METHOD OF SURFACE COATING BY SPRAYING PARTICLES USING A CRYOGENIC CARRIER FLUID

(71) Applicant: L'Air Liquide, Societe Anonyme Pour I'Etude et I'Exploitation des Procedes Georges Claude, Paris (FR)

(72) Inventors: Frédéric Richard, Parmain (FR); Jacques Quintard, Presies (FR); Charles Truchot, Saint Nazaire (FR)

(21) Appl. No.: 14/364,896

(22) PCT Filed: Oct. 1, 2012
(86) PCT No.: PCT/FR2012/052219

§ 371 Date: Jun. 12, 2014

(30) Foreign Application Priority Data
Dec. 12, 2011 (FR) 1161473

(51) Int. Cl. B05D 1/02; B05D 1/12

(52) U.S. Cl. CPC B05D 1/025; B05D 1/12
USPC 427/421.1; 118/300

(57) ABSTRACT

The invention relates to a method for producing a coating, with a material, of at least one part of the surface of a substrate by spraying particles of the material toward the substrate to be coated using a carrier fluid containing a compound chosen from the gases of the air. According to the invention, the carrier fluid is in the liquid state, at a pressure of at least 300 bar and at a temperature below O ° C. Associated surface treatment apparatus, especially apparatus for carrying out a method according to the invention.

### CROSS-REFERENCE TO RELATED APPLICATIONS

This application is a 371 of International Application PCT/FR2012/052219, filed Oct. 1, 2012, which claims priority to French Application No. 1161473, filed Dec. 12, 2011, the entire contents of which are incorporated herein by reference.

### BACKGROUND

The invention relates to a method for producing a coating of the surface of a substrate by means of a material, said method being based on the spraying of particles of said material towards the substrate to be coated by means of a carrier fluid, in particular liquid nitrogen, and an installation able to implement said method.

Currently there exist various techniques for effecting the coating of the surface of a substrate with a material. In particular, thermal spraying makes it possible to produce coatings of good quality, that is to say thick, homogeneous and compact and having good adhesion to the substrate treated.

Producing a coating by thermal spraying is based on the use of a carrier gas in order to accelerate and transport fine particles of the material constituting the coating on the substrate to be coated. The particles, with a characteristic size ranging typically from 5 to 100 μm, in general in the form of powder, are thus sprayed towards the substrate, on which they are crushed and accumulate in order to form the desired coating. The coatings obtained generally have a thickness of around a few tens to a hundreds of μm.

The technique of coating by thermal spraying in general involves the particles being melted or partially melted in order to assist attachment thereof to the substrate.

Some methods, such as thermal spraying by torch or blown arc plasma, lead to the complete melting of the particles sprayed. In these methods, the heating of the particles beyond their melting point then fulfils a preponderant role compared with the speed of the carrier gas in order to assist the adhesion of the coating to the substrate.

Other methods, such as ultrasonic spraying, consist, still while effecting complete or almost complete fusion of the sprayed particles, of significantly increasing their spraying speed in order to increase their impact force on the substrate.

However, these coating techniques are all based on a significant heating of the sprayed particles, which leads to the generation of high thermal stresses on the substrate, as well as to the oxidation and/or metallurgical transformation of the materials sprayed.

To improve these techniques, a coating method by so-called “cold” spraying has been proposed, as described in the documents EP-A-0911423 and EP-A-0911425.

### SUMMARY

In these cases, the particles are sprayed onto the substrate to be coated using a carrier gas heated to a temperature typically between 30° and 900° C., the carrier gas in general containing a neutral gas, such as nitrogen or helium, at a pressure of between 5 and 50 bar.

Normally, the carrier gas is accelerated to supersonic speeds, around 350 to 1600 m/s, in a nozzle with a so-called “Laval” geometry, that is to say where the gas conduit comprises an upstream portion of convergent shape and a downstream portion of divergent shape. The particles of material to be sprayed are introduced, generally in the form of powder, into the nozzle and sprayed towards the substrate. The impact of the particles on the substrate, through their high kinetic energy, causes a plastic deformation of them, releasing sufficient energy to ensure attachment thereof to the substrate.

The carrier gases used in general contain compounds chosen from air gases, such as helium or nitrogen, and preferably neutral gases. Air, oxygen or any compound containing oxygen are generally proscribed in order to limit oxidation of the sprayed particles.

The traditional cold spraying methods have carrier gas consumptions typically between a few Nm3/h and 150 Nm3/h, that is to say between approximately 150 and 2500 litres/min. For an equivalent spraying installation, the hourly consumption of carrier gas is comparable whether nitrogen or helium is used.

However, at the end of 2011, the cost of the helium molecule in France was approximately seventy times more expensive than the cost of the nitrogen molecule. Consequently, from an economic point of view, the use of nitrogen is preferable to that of helium.

Cold spraying makes it possible to produce coatings with carrier gases at temperatures generally lower than the melting point of the material sprayed, at the carrier gas pressure used. In this way the problems of change of structure and oxidation of the sprayed material are limited, as well as the thermal constraints suffered by the substrate.

However, the traditional cold spraying methods continue to have several drawbacks.

First of all, in order to form a quality coating, the particles must be sprayed at a velocity exceeding a so-called critical velocity. In other words, if the velocity of the particles is below the critical velocity, there is no formation of a layer of coating adherent to the substrate, by the simple erosion of the substrate by the sprayed particles, if however the hardness of said particles is greater than that of said substrate. This critical velocity depends on the nature of the material sprayed. For example, the document by T Schmidt et al, “Development of a Generalized Parameter Window for Cold Spray Deposition”, Acta Mater, 2006, 54(3), pages 729-742, mentions for copper a critical velocity of 500 m/s and for magnesium a critical velocity of 860 m/s.

To achieve these speeds, it is necessary to heat the carrier gas. This is because, the more the temperature of the carrier gas increases, the more its velocity increases and the greater the acceleration of the particles. As a result the quantity of kinetic energy available for the deformation of said particles on impact on the substrate increases, which leads to the production of coatings that are more adherent and more compact. The temperature to which the carrier gas must be heated depends also on the nature of the material sprayed.

Apart from the need to integrate means for heating the gas in the coating installation, making said installation more complex, this poses a problem when it is wished to spray particles of materials the melting point of which at atmospheric pressure is relatively low. This is the case for example with metal such as magnesium, the melting point of which is around 650° C., lead, the melting point of which is around 327° C., tin, the melting point of which is around 230° C., zinc, the melting point of which is around 400° C., or aluminium, the melting point of which is around 700° C., or polymer materials.

For these materials said to have a low melting point, obtaining velocities of sprayed particles above the critical velocities (for example 860 m/s for magnesium) requires the use of gaseous nitrogen heated to temperatures above the melting points of the sprayed particles, which is to be avoided because of the problems of alteration of the metallurgical properties of the material sprayed and resulting thermal stresses on the substrate.

It is therefore essential to use helium as the carrier gas. Helium being a light gas, it can be accelerated at a lower temperature than nitrogen for an equivalent velocity.

However, the use of helium is not an ideal solution since it has the drawback of being expensive. In addition, helium is a resource that is becoming scarce.

Moreover, even in cold spraying, and in particular with nitrogen, the temperatures of the carrier gases remain relatively high, that is to say between 200° and 900° C. As explained previously, these temperatures are essential for obtaining sprayed particle velocities sufficient for achieving quality coatings.

However, these temperatures may prove to be incompatible with some applications, in particular when the substrates to be coated are fragile, for example sensitive to thermal shocks, such as ceramics, or liable to undergo deformations at the temperatures involved, or when the coatings produced are thick, typically more than 500 μm. The stresses suffered by the substrate are in these cases even greater.

Finally, the conventional cold spraying methods make it necessary to work at a distance of around 0.5 to 2.5 cm with respect to the surface of the substrate to be coated. This distance corresponds to the distance separating the surface of the treated substrate and the end of the spraying tool from which the particles are sprayed. Beyond this distance, the sprayed particles no longer have sufficient velocity to construct a quality coating on the treated substrate.

This therefore constitutes a significant limitation in the case where the substrate has an irregular surface, resulting for example from high roughness, unevenness or holes formed intentionally in the depth of the substrate, the bottom of these areas then being able to be situated beyond the distance at which the particles have a sufficient spraying velocity to attach and adhere to the substrate.

The problem to be solved is consequently proposing a method for producing the coating of a substrate by spraying a material that is improved, that is to say for which the aforementioned drawbacks no longer exist or are considerably limited, enabling particles of said material to be sprayed at sufficiently high velocities to form a quality coating, that is to say thick, adherent to the substrate, homogeneous and compact, i.e. without porosities or with a reduced level of porosities, without having recourse to the use of a heated carrier gas, while improving the tolerance in positioning of the spray tool with respect to the treated substrate.

The solution of the invention is then a method for producing a coating of at least part of the surface of a substrate by means of the material by spraying particles of said material towards the substrate and coating by means of a carrier fluid containing a compound chosen from air gases, characterised in that said carrier fluid is in the liquid state, at a pressure of at least 300 bar and at a temperature below 0° C.

This is because the inventors of the present invention have shown that the use of a carrier fluid in the liquid state, at high pressure, that is to say at least 300 bar, and at a temperature below 0° C., in particular liquid nitrogen, made it possible to spray particles of material at a sufficiently high velocity to enable attachment thereof to a substrate and from there the rapid construction of an adherent coating.

The major advantage of the invention lies in the use of a carrier fluid containing a compound in the liquid state, in particular liquid nitrogen, the temperature of which is below 0° C., instead of a carrier gas containing a compound at a temperature of around 200° to 900° C.

Firstly, this reduces even more effectively, or even eliminates, the phenomenon of oxidation of the sprayed particles occurring in the cold spraying methods of the prior art.

Secondly, the risk of subjecting the substrate to high mechanical stresses is reduced, which is particularly advantageous for producing very thick coatings, typically between 500 and 2000 μm. Whereas in the prior art producing these coatings makes it necessary to successively deposit numerous fine layers while complying with a waiting time between each layer to enable the temperature of the substrate to decrease, the method of the invention minimises the temperature rise of the substrate and therefore reduces the waiting time between each layer. The result is an increase in the efficiency of the method.

Moreover, according to the embodiment considered, the invention may comprise one or more of the following features:
the carrier fluid has a temperature of below −10° C., preferably below −20° C.,
the carrier fluid has a temperature above −200° C., preferably above −180° C., preferably again above −160° C.,
the carrier fluid has a pressure of below 4000 bar,
the carrier fluid has a pressure of below 1000 bar,
the carrier fluid is liquid nitrogen. In other words, the compound contained in the carrier fluid is nitrogen,
the particles of material are conveyed by the carrier fluid at a velocity of between 300 and 2500 m/s, preferably between 300 and 1700 m/s,
the carrier fluid is delivered at a rate of between 1 and 20 litres/min, preferably between 2 and 15 litres/min,
the particles of material are formed from a metal, polymer, ceramic or composite material,
the particles of material are non-molten,
the particles of material have a mean size of between 5 and 100 μm and are in powder form,
the substrate is formed from a metal, polymer, ceramic or composite material,
the coating of material produced on the substrate has a thickness of between 50 and 2000 μm.
the particles of material and the carrier fluid form a mixture dispensed by a spray tool in the form of a jet directed towards the substrate, the downstream end of said spray tool being positioned at a distance of between 5 and 50 cm from the surface to be coated of the substrate, preferably between 10 and 30 cm.

Moreover, the invention concerns a surface treatment installation, in particular an installation for implementing a method according to the invention, comprising a mixing chamber supplied by a source of particles of material and a source of carrier fluid, said source of carrier fluid cooperating with a compression system and two heat exchangers in order to produce and supply carrier fluid to said mixing chamber at a pressure above 300 bar and at of temperature below 0° C.

### BRIEF DESCRIPTION OF THE DRAWING

FIG. 1 illustates a method for producing a device able to implement the coating method of the invention.

### DETAILED DESCRIPTION OF THE PREFERRED EMBODIMENTS

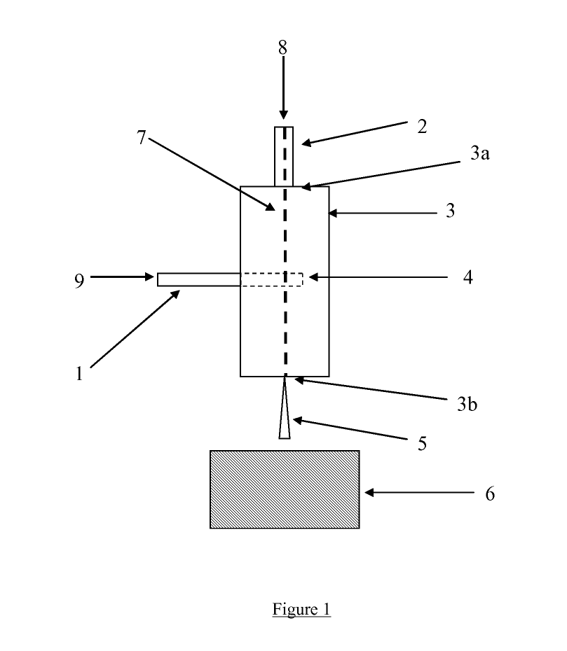

The invention will now be better understood by means of the following detailed description given with reference to the accompanying FIG. 1 showing schematically a method for producing a device able to implement the coating method of the invention.

The method of the invention is based on the use of a carrier fluid 8 containing a compound chosen from air gases in order to spray particles of said material 9 towards the surface of the substrate 6 to be coated and thus to produce the coating, by said material 9, of at least part of the surface of the substrate 6.

As can be seen in FIG. 1, a spray tool 3 is supplied by a flow of carrier fluid 8, represented by the arrow 8, by means of a fluid-feed pipe 2 connected fluidically to the upstream end 3a of the tool 3. According to the invention, the carrier fluid 8 is formed from a compound in the liquid state, at a pressure of at least 300 bar and at a temperature below 0° C.

It should be noted that the pressure of the carrier fluid 8 is expressed in bar absolute. In the context of the present invention, the term bar therefore means bar absolute.

The compound is chosen from air gases, that is to say gases naturally present in air, and may in particular be nitrogen or helium. The carrier fluid 8 is preferably liquid nitrogen, which has the advantage of being inert and less expensive than helium. In other words, the compound contained in the carrier fluid 8 is in this case nitrogen.

Advantageously, the carrier fluid 8 is free from oxygen, so as to minimise the risk of oxidation of the material 9 sprayed.

A source of carrier fluid 8 (not shown) is arranged upstream of the pipe 2 and connected fluidically thereto. The principle of the obtaining of carrier fluid in the liquid state, at a temperature below 0° C. and at high pressure, or in other words high-pressure cryogenic fluids, is known and described in detail in the documents U.S. Pat. No. 7,310,955 and U.S. Pat. No. 7,316,363.

Typically an installation for producing cryogenic fluid, for example liquid nitrogen, at high pressure comprises a reservoir for storing carrier fluid in the liquid state, which, via a line for supplying liquid carrier fluid at low pressure, that is to say at approximately 3 to 6 bar and at a temperature of approximately −180° C., supplies a compression device, with compressor and heat exchanger upstream, enabling the liquid nitrogen to be put at ultra-high pressure.

The compression device therefore compresses the liquid nitrogen coming from the storage reservoir.

The liquid nitrogen at the first pressure is then conveyed via a conveying line as far as a downstream heat exchanger where the liquid nitrogen undergoes cooling with liquid nitrogen at atmospheric pressure in order to obtain typically liquid nitrogen.

The result is liquid nitrogen at a pressure typically higher than 300 bar, generally between 1000 bar and 4000 bar, and at a temperature below 0° C., typically between −10° C. and −200° C., which is sent to the spray tool 3.

The flow of carrier fluid 8 follows a path shown by the broken line 7 in the spray tool 3. It is delivered at a rate of between 1 and 20 litres/min, preferably between 2 and 15 litres/min.

The carrier fluid 8 is delivered into the spray tool 3 at a temperature below 0° C., preferably below −10° C., preferably again below −20° C. Advantageously, the carrier fluid 8 has a temperature above −200° C., preferably above −180° C., preferably above −180° C., preferably again above −160° C. The pressure of the carrier fluid 8 is at least 300 bar, and preferably remains below 4000 bar. It is also possible in some cases to implement the method of the invention at pressures of carrier fluid 8 below 1000 bar.

The spray tool 3 is also supplied by a flow of particles of material 9 to be sprayed. This flow is distributed by a conduit 1. The particles of material 9 have a characteristic size of around 5 to 100 μm. Advantageously, the material 9 is distributed in the form of powder.

More precisely, the spray tool 3 comprises a mixing chamber 4 supplied with the flow of carrier fluid 8 and by the flow of particles of material 9.

According to a particular embodiment, the mixing chamber 4 is able and designed to create, by venturi effect, a negative pressure used to suck the particles of material 9 towards said mixing chamber 4.

In general terms, in the context of the invention, the mixing chamber 4 is able and designed to mix the flow of carrier fluid 8 and the flow of particles of material 9 so that the particles of material 9 are transported and accelerated by the flow of carrier fluid 8, at a velocity of around the velocity of the carrier fluid 8.

The mixture of particles of material 9 and carrier fluid 8 is then dispensed by an outlet orifice situated at the downstream end 3b of the spray tool 3 in the form of a jet 5 directed towards the substrate 6 to be coated. Depending on the pressure and temperature of the carrier fluid 8, the downstream end 3b of the spray tool 3 is positioned at a distance of between 5 and 50 cm from the surface to be coated of the substrate 6, preferably between 10 and 30 cm. The method of the invention is therefore characterised by large working distances, which is advantageous when the coating must be produced on an irregular surface or one having holes or hollows.

According to the invention, the carrier fluid is dispensed in the spray tool 3 at a velocity of between Mach 1 and Mach 7, that is to say between 300 and 2500 m/s, preferably between Mach 1 and Mach 5, that is to say between approximately 300 and 1700 m/s, the velocity Mach 1 corresponding to the speed of sound in air, 340 m/s, Mach 2 corresponding to the speed of sound multiplied by a factor of 2, and so on. The particles of material 9 are thus conveyed by the carrier fluid 8 at a velocity of between 300 and 2500 m/s, preferably between 300 and 1700 m/s.

These spraying velocities lead to the production of coatings of material 9 on the substrate 6 with a thickness typically between 50 and 2000 μm. To do this, the spray tool 3 is moved by the surface of the substrate to be coated at a so-called sweeping speed, this speed varying according to the thickness of the coating to be produced or the velocity of the particles being sprayed. The coating is produced on all or part of the surface of the substrate 6 and deposited in the form of one or more layers of material 9. In the context of a coating in the form of several layers, the layers will be deposited immediately after one another, or after a so-called idle time has elapsed.

Advantageously, the particles of material 9 are transported by the carrier fluid 8 in the solid state, that is to say they are non-melted. The quantity by mass of particles of material 9 sprayed per unit of time by means of the carrier fluid 8 is typically between 1 and 5 kg/h.

Materials 9 of various natures, typically metal, polymer, ceramic or composite materials, can thus coat various types of substrate 6, themselves formed by metal, polymer, ceramic or composite materials.

### EXAMPLES

In order to demonstrate the efficacy of a coating method according to the invention for coating at least part of the surface of a substrate with a material, copper coatings were produced in accordance with the invention on several types of substrate: a sheet of AG5 aluminium alloy with a thickness of 10 mm, a sheet of stainless steel type 304 with a thickness of 2 mm and a steel sheet of the DX54 type used in the automobile industry with a thickness of 2 mm. The material sprayed was pure copper powder with a mean grain size of around 50 μm.

The carrier fluid used was liquid nitrogen at a pressure of around 3200 bar and a temperature of around −155° C., delivered by an ejection tool with an outlet orifice with a diameter of 0.3 mm. This leads to a flow of liquid carrier fluid with a flow rate through the spray tool of around 3 litres/min and a velocity of around 710 m/s. The sweeping speed of the spray tool, that is to say its speed of movement above the surface of the substrate to be coated, was around 1 m/min.

By way of indication, this speed is comparable to that which can be achieved with a cold spraying method according to the prior art, and this without the fluid being heated. In addition, it should be noted that the flow rate of 3 litres/min of liquid nitrogen corresponds, at the pressure or around 3200 bar involved, to 144 Nm3/h of gaseous nitrogen, which is comparable to the flow rates of gaseous nitrogen used with the cold spraying method according to the prior art.

During these tests, the distance between the outlet orifice of the ejection tool and the surface of the substrate to be coated was around 20 cm. The velocity of the particles at the discharge from the spray tool was estimated at between Mach 2 and Mach 3.

These tests led to the formation of copper coatings with a thickness of approximately 150 μm, having good properties of adhesion to the substrates treated.

Tests were also carried out with liquid nitrogen at −48° C., all other conditions being identical, and also lead to the production of a copper coating on the substrates tested. The temperature of −48° C. has the advantage for some applications of limiting the cooling of the substrate and therefore limiting, or even eliminating, condensation on the substrate of the water contained in the air.

These tests therefore clearly demonstrate the efficacy of the invention, which makes it possible to spray particles of material at sufficiently high velocities to form a coating consisting of said material that adheres to the substrate to be coated, without having recourse to the use of a heated carrier gas.

Moreover, the solution of the invention also concerns a surface treatment installation, in particular an installation for implementing a method of coating at least part of the surface of a substrate to be coated by a given material. This installation is characterised essentially by the fact that it comprises a mixing chamber supplied by a source of particles of the material to be sprayed and a source of carrier fluid, said source of carrier fluid cooperating with a compression system and two heat exchangers in order to produce and supply said mixing chamber with the carrier fluid at a pressure above 300 bar and a temperature below 0° C.

1.-15. (canceled)

16. A method for producing a coating on at least part of the surface of a substrate by spraying particles of a coating material towards the part of the substrate to be coated by means of a carrier fluid containing a compound chosen from air gases, wherein the carrier fluid is in the liquid state, at a pressure of at least 300 bar and at a temperature below 0° C.

17. The method according to claim 16, wherein the carrier fluid has a temperature below −10° C.

18. The method according to claim 16, wherein the carrier fluid has a temperature above −200° C.

19. The method according to claim 16, wherein the carrier fluid has a pressure below 4000 bar.

20. The method according to claim 19, wherein the carrier fluid has a pressure below 1000 bar.

21. The method according to claim 16, wherein the carrier fluid is liquid nitrogen.

22. The method according to claim 16, wherein the material comprises particles that are conveyed by the carrier fluid at a velocity of between 300 and 2500 m/s.

23. The method according to claim 16, wherein the carrier fluid is delivered at a flow rate of between 1 and 20 liters/min.

24. The method according to claim 16, wherein the particles of material are formed of a metal, polymer, ceramic or composite material.

25. The method according to claim 16, wherein the particles of material are non-melted.

26. The method according to claim 16, wherein the particles of material have a mean size of between 5 and 100 μm and are in the form of powder.

27. The method according to claim 16, wherein the substrate is formed of a metal, polymer, ceramic or composite material.

28. The method according to claim 16, wherein the coating of material produced on the substrate has a thickness of between 50 and 2000 μm.

29. The method according to claim 16, wherein the particles of material and the carrier fluid form a mixture distributed by a spray tool in the form of a jet directed towards the substrate, the downstream end of said spray tool being positioned at a distance of between 5 and 50 cm from the surface to be coated of the substrate.

30. The surface treatment installation, in particular an installation for implementing a method according to claim 16, comprising a mixing chamber supplied by a source of particles of material and a source of carrier fluid, said source of carrier fluid cooperating with a compression system of two heat exchangers in order to produce and supply said mixing chamber with the carrier fluid at a pressure above 300 bar and at a temperature below 0° C.
